(19) United States
(12) Patent Application Publication
(10) Pub. No.: US 2026/0087111 A1
(43) Pub. Date: Mar. 26, 2026

(54) PERMISSIONS ENFORCEMENT SYSTEM FOR A COLLABORATION SYSTEM

(71) Applicant: Atlassian Pty Ltd., Sydney (AU)

(72) Inventors: Sandeep Ravindra Tengali, Sydney (AU); Benjamin Magro, Sydney (AU); Sidney Shek, Mountain View, CA (US)

(21) Appl. No.: 18/898,611

(22) Filed: Sep. 26, 2024

(51) Int. Cl. G06F 21/31

(52) U.S. Cl. CPC G06F 21/31

(57) ABSTRACT

A collaboration system including multiple software platforms includes a centralized permissions enforcement platform that determines user access based on negative permissions (what users are not allowed to access) rather than positive permissions (what they are allowed to access). In particular, each user may be associated with a set of authorization-denied classifications that describe properties or attributes of data or objects that the respective user is not authorized to view. In this manner, a set of properties of an arbitrary content item can be compared against a user's authorization-denied classification set and, if an intersection between those two sets is non-null, then access to the content by the respective user is denied.

### TECHNICAL FIELD

Embodiments described herein relate to authentication for multi-user collaborative web services and in particular to performant and scalable permissions enforcement systems for collaboration systems.

### BACKGROUND

Organizations retain large volumes of digital content created, managed, or modified by employees. In many cases, organizations license access for their employees or customers to one or more collaboration systems to generate, view, and/or modify digital content. Conventionally, permission to access or modify an organization's content is controlled and restricted and/or limited to authenticated users.

In many cases, individual users have user-specific or role-specific permissions. In other words, not all employees or roles of the organization may be permitted to access and/or modify all content. Because permissions schemas vary in an organization-specific, configuration-specific way, conventional collaboration systems are configured to validate permissions in respect to each request for content made by each user.

However, as an organization grows, the volume of that organization's content necessitates robust internal search functionality to equip authenticated users with appropriate tools to quickly locate content of interest. Conventionally, respecting permissions while executing a search operation against all or substantially all organization content is computationally expensive (and slow) because every individual search result needs to be independently validated as permitted to be viewed by the requesting user.

### SUMMARY

Embodiments described herein relate to a permission enforcement platform for a collaboration system that includes at least a first and second software platform. The permission enforcement platform includes a host server with a processor and memory. The memory stores instructions that serve to instantiate an authorization classification handler.

The authorization classification handler can be configured to: receive a request from a requesting platform (e.g., either the first software platform or the second software platform of the collaboration system); extract a user token from the request; and generate a first set of authorization-denied classifications based on the user token. More simply, the permissions enforcement platform determines a set of classes of object types, object locations, data sources, or the like that an authenticated user is not authorized to access.

This set of classifications can be merged with other sets, such as sets with classifications related to system-level operations, platform-level operations or data, feature flags, or the like. These merged sets of authorization-denied classifications can be cached and/or calculated in real-time to expedite permissions decisions in respect of the user and a large and varied number of content items.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified system for providing content items of a collaboration system.

FIG. 2 depicts a simplified system diagram of a collaboration system including a permissions enforcement system as described herein.

FIG. 3 depicts a graphical user interface associated with an active and authenticated session of a frontend application instance of a software platform, as described herein, operating with conventional permissions enforcement techniques.

FIG. 4 depicts a graphical user interface associated with a first active and authenticated session of a frontend application instance of a software platform, as described herein, operating with a category-based permissions enforcement system as described herein.

FIG. 5 depicts a flowchart depicting operations of a method of operating a permissions enforcement system as described herein.

FIG. 6 depicts a flowchart depicting operations of another method of operating a permissions enforcement system as described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to collaboration systems that can include one or more purpose-configured software platforms. Specifically, "collaboration systems" as described herein can be configured to facilitate sharing of digital information or content between users authenticated to one or more software platforms of the system.

For example, an organization can maintain a collaboration system that includes a documentation platform and an issue tracking platform. The two platforms may be configured to integrate and/or share information, or may function entirely separately. In some constructions, the system can include a single sign on service that manages user profiles for both the documentation platform and the issue tracking platform. In this manner, an employee of the organization can have a single set of credentials that can be provided by the employee to either or both the documentation platform or the issue tracking platform.

More specifically, a collaboration system as described herein includes a centralized permissions management platform (herein, a "permissions enforcement service" or "permissions enforcement platform") configured to enforce user-specific and/or role-specific content access permissions in a performant and highly scalable manner. Broadly, a permissions enforcement platform as described herein is configured to determine negative user permissions once (e.g., what a user is not permitted to do in a system) in order to create a data structure or filter that can be used multiple times to determine whether particular content items are allowed to be accessed by the user. Such systems are described in greater detail below.

Generally and broadly, a user may be authenticated to a system or a platform as described herein by providing to a frontend application instance (e.g., a browser application) a username and password, and/or any other suitable credential set (e.g., one-time passcodes, multi-factor user tokens, and the like).

A directory service of a collaboration system can be leveraged to compare the user-provided credentials to a registry of users to determine whether the credentials are valid. Upon determining that the credentials are valid, a collaboration system may generate a user token (e.g., JavaScript Web Token or similar) that can be communicated back to a user's frontend application instance, thereby defining an active session at the user's frontend application instance. In this manner, so long as the session is active and not expired, the user token can be provided with sequent requests from the same frontend application instance to prevent the user from having to provide credentials on a repeating basis.

In certain configurations of this architecture, an active session enables a user to conveniently access content that the user is permitted to access within a collaboration system. More specifically, in one example, when a user makes a request for a specific content item, the request includes the user token in addition to data identifying the requested content (e.g., an address, content identifier, or the like). The collaboration system can receive this request and provide the user token along with information in respect of the requested content to a permission management system or permission enforcement system that determines whether this specific user is authorized to engage with this specific content. This operation may be referred to herein as a "permission validation" or a "permission check."

As a collaboration system scales, however, performing permission validations in respect of many content items and many users can result in significant computation, bandwidth utilization, and memory utilization for conventionally architected systems. For example, in some cases, a collaboration system can include a software platform configured as a collaborative documentation platform. Each page of the documentation platform can include multiple content items (e.g., media, cross-link previews, and the like), each of which necessitates a separate permission validation operation when a single user loads each respective page.

Another challenge develops as a collaboration system scales. In particular, as noted above, the more content a collaboration system stores, the greater the need for a function search of that platform's content becomes. In these examples, each time a user leverages the search function, every result that may be shown to the user must be separately permission-validated specifically because a user cannot be shown a search result to content that the user does not have permission to view.

For example, if a user initiates a query that offers one hundred results, some systems may require one hundred or more separate permission validation operations, significantly throttling performance of the search function, if not the collaboration system itself or software platforms thereof.

A conventional solution to these problems is to generalize permissions to higher-order objects only (herein "macro-level permissions" techniques). For example, a user may be permitted to access all pages within a particular section, regardless of the content contained in those pages. In another example, a user may be permitted to access all content of a particular workspace, including any pages or content items stored within that workspace. This conventional solution reduces the number of calls for permission validation, but exposes an organization to potential liability -- it becomes essential that every employee of an organization correctly categorize, organize, and store confidential data according to organization policy. Further, it becomes cumbersome and time consuming to maintain such permissions as a system or a data set grows.

To address these and other problems with conventional macro-level permissions validation operations at scale, embodiments described herein include a permission enforcement system configured to evaluate permissions based on classifications of data, data sources, objects, and/or object attributes within a software platform, regardless of the where that data are stored, of a collaboration system – and in particular, negative permissions classifications of such data – in respect of a single user. More specifically, in lieu of affirmative associations between content organization levels or buckets (e.g., pages, spaces, projects, and so on) with specific users or roles, embodiments described herein determine what content attributes or types of users or role is not permitted to access. More broadly, a list or set can be determined and/or maintained for each user or role within a system. Each item of the set is associated with an attribute or property or tag associated with content within the system that the user is not allowed to access. In some cases, a property, attribute or tag can describe a manner in which data is accessed, in addition to or separate from the data itself. For example, a first tag may prevent cross-linking content between particular platforms. In this manner, if a particular content item – regardless of how that content item is linked, stored, or otherwise organized within an organization's data – exhibits a property or attribute that is on a user's "list" of not-allowed attributes, the content item will not be accessible to the user.

More specifically, a user may be associated with a first set of "authorization-denied" classifications, and individual content items may be associated with a second set of attributes, properties, or the like. An intersection of those two sets can be calculated. If the intersection is nonzero (i.e., contains more than zero elements), then the user's request to access the content is/should be denied. Phrased in a more simple and non-limiting manner, if any classification of particular content matches any of the user's "authorization-denied" classifications, then the user is not permitted to access that content.

In some embodiments, a user's set of authorization-denied classifications can be calculated periodically and stored in a permissions cache. However, in many embodiments, such classifications can be defined by a collection of multiple schemas, each maintained in respect of a different aspect of a collaboration system, software system, or content item available therein. For example, a first schema can define an authorization-denied classification for some data type or object attribute on an organization-wide basis whereas a second schema can define an authorization-denied classification for some data type or object attribute on a platform-specific basis whereas a third schema can define an authorization-denied classification for some data type or object attribute on a document or page-specific basis. In these examples, each level of the schema hierarchy can define one or more authorization-denied classifications that are associable to a particular user or role.

In this manner, each level of the hierarchy defines a unique permission rule or set of permission rules that applies at that level and below. More generally, a first hierarchy level may define a first set of authorization-denied classifications that apply in respect of a particular user or particular role, and a second hierarchy level may define a second set of authorization-denied classification that apply to the same user and the same user role. These two sets can be joined or merged to define a merged set of authorization-denied classification in respect of a particular user and that user's role across an entire collaboration system (i.e., across multiple software platforms).

Thereafter, the merged set of authorization-denied classifications associated with a particular user or role can be used as a filter to determine whether particular content is accessible to that particular user. Because the merged set can be represented as a single static data structure, it can be used for rapidly determining a particular user's content-specific access permissions across an entire organization.

More specifically, a merged set as described herein can be used to determine permissions in respect of a particular content item and a particular user without repeated network calls (e.g., to a permissions validation service, or the like), or without repeated database queries, or without unnecessary bandwidth utilization. More simply, determining permissions as described herein dramatically improves the performance of the overall computing system, reduces bandwidth utilization, and increases responsiveness, especially in circumstances requiring multiple permission validation operations, such as when servicing a query for an arbitrary number of content items across one or more software platforms of a collaboration system.

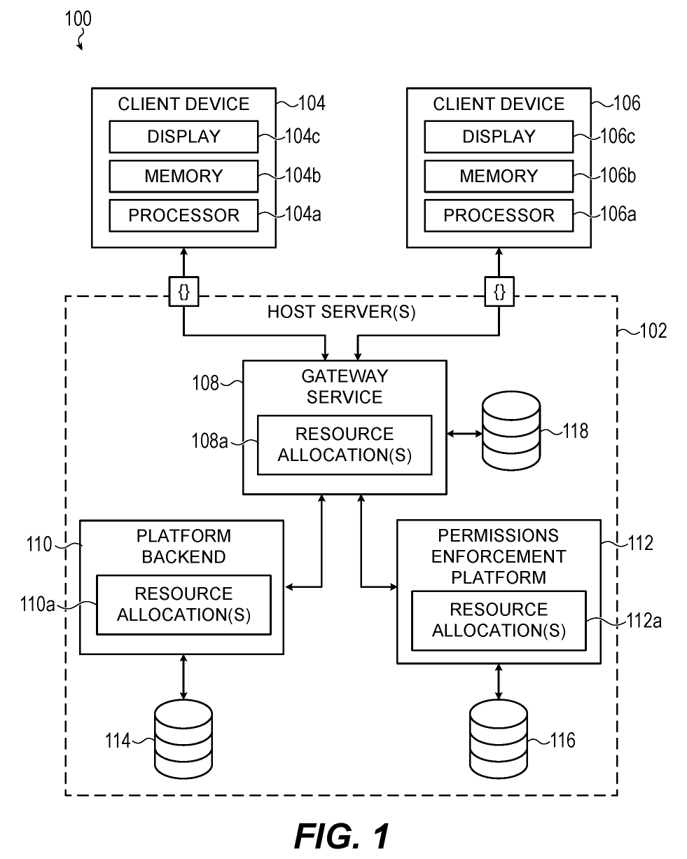

These foregoing and other embodiments are discussed below with reference to FIGS. 1-6. The following examples are provided with respect to these figures for purposes of illustration and example and should not be construed as limiting the disclosure to the explicit examples depicted.

FIG. 1 depicts a simplified diagram of a collaboration system, as described herein. The system is depicted as implemented in a client-server architecture, but it may be appreciated that this is merely one example and that other communications architectures are possible. In accordance with the examples provided herein, the system of FIG. 1 can be used to provide a series of interfaces to a document management system, page management system, collaboration system or other digital content management system via a computer network. Collectively, such systems can be referred to herein as "software platforms."

As described herein, a collaboration system can include multiple software platforms, configured to operate independently or collaboratively. For example, an organization may license a bundle of software, each of which may be associated with different preferred permissions schemas. For example, an organization can include documentation platform, a code repository platform, an issue tracking platform, and an information technology service management platform.

In this manner, a collection of software platforms can define a single collaboration system leveraged by employees of an organization to advance projects and complete work. For simplicity of description, many embodiments that follow depict and reference a single software platform but it is appreciated that this is merely one construction.

The system of FIG. 1 depicts an example configuration in which multiple client devices may access a host server of a set of host servers via a computer network. The computer network may include a distributed network which may include local networks, gateways, and networking services provided by one or more internet service providers. The client devices are able to create, search, view and share content via the network either directly or through the various services provided by the host server.

The client devices execute or operate respective example client applications, which may include a dedicated client-side application or may be a web browser client application. The client applications, may also be referred to herein as frontend applications and may provide one or more graphical user interfaces for interfacing with the backend applications or services provided by the host server. The client devices typically include a display, processing unit, computer memory, and other hardware components.

The host server may include multiple platforms, which may be part of a collaboration system. For example, the multiple platforms may include, but are not limited to, a content collaboration service, a recommendation engine service, a page or document creation and management service, content wiki services, messaging and event feed services, and other collaboration or data management services.

A platform of the multiple platforms may be implemented as one or more instances of software executing on one or more host servers of the set of host servers. The multiple platforms may also provide different services including, for example, issue tracking services for creating, managing, and tracking issues for software development, bug tracking, and/or information technology service management (ITSM) services.

For embodiments described herein, a system includes a host server of a set of host servers, which may be a host of multiple platforms. The host server, which may use one or more virtual or physical computing resources (collectively referred to in many cases as a "cloud platform"). In some cases, the set of host servers can be physically collocated or in other cases, each may be positioned in a geographically distributed manner.

The host server can be communicably coupled to one or more client devices by a network. The host server of the set of servers hosts services and/or other server components or modules to support infrastructure for one or more backend applications, each of which may be associated with a particular software platform, such as a documentation platform or an issue tracking platform. For example, the host server may host a content collaboration service, a permissions enforcement platform, a recommendation engine service, and other services. The host server may also include an event log module, and a directory service. The host server may also have a local cache of pages of user-generated content.

The content collaboration service may provide an interface to client devices, and to the one or more backend applications, and/or software platforms, such as a documentation platform or an issue tracking platform. The client devices may be executing a frontend application that consumes services provided by the content collaboration service. Accordingly, a user of a client device may create, edit, search, and/or view electronic documents, pages, or digital content using the interface provided by the content collaboration service. By way of a non-limiting example, the interface provided by the content collaboration service may be web service based, such as a RESTful web service. The electronic documents, pages, or digital content may be transferred between a client device and a host server using one or more of JSON, XML, HTML, and/or a proprietary document format.

A content collaboration service as described herein allows the user to create, edit, search, and/or view electronic documents, pages, or digital content and may also be referred to herein as a document management system or page management system. The content collaboration service may allow the user to create, edit, search, and/or view electronic documents, pages, or digital content based on authentication and/or authorization of a user using the permissions enforcement platform.

The permissions enforcement platform may authenticate a user based on user credentials, which may include a username or other user identification, password or PIN, biometric data, or other user-identifying information. The user credentials may be stored and tracked using a token, authentication cookie, or other similar cryptographic data structure or element.

Upon successful authentication/authorization of a user, the content collaboration service may access a directory service to obtain a user profile associated with an authenticated user of a client device. The user profile associated with the user may suggest various permissions of a user for creating, editing, accessing, searching, and/or viewing various electronic documents, pages, or digital content.

The user profile associated with the user may also identify other details of the user, including but not limited to, a role of a user in an organization, one or more groups to which a user is a member, other users of the one or more groups to which the user is a member, one or more projects related to the user, one or more issues or tickets (managed by an issue tracking system) the user is assigned to, and so on.

The user profile may include, but is not limited to, user permission settings or profiles, and user history that may include user logs or event histories, system settings, administrator profile settings, content space settings, and other system profile data associated with the backend applications described herein and associated with the user.

Accordingly, the user of the client device may create, edit, access, search, and/or view electronic documents, pages, or digital content based on permissions granted to the user based on the retrieved user profile. The other services described herein may provide a user interface to other applications or services, for example, an issue tracking system, to create, edit, search, or view an issue or ticket on the issue tracking system. Thus, the content collaboration service may generate electronic documents, pages, or digital content which may also include data associated with one or more issues managed by the issue tracking system.

The system may also include one or more event log modules, which may track and/or store user actions, system events, or other data generated in accordance with activity performed by the system users. Specifically, the event log module may include navigation events that are generated in response to user selection or navigation to various pages, documents, or other content on the system. The navigation events may be used to determine which pages have been navigated to by a user either before or after a particular page or document.

In some cases, the navigation events are used to determine a set of pages or documents that have been navigated to or viewed by the user within a session or designated time frame. The user event log may also be used to store other properties of a session including, for example, average dwell time for a page or document, user interactions with content including likes, comments, and other feedback, other application use or other user activity observed during a session or time period. As described herein, data stored and tracked by the event logs may be used to determine a relatedness score or other measure of relevance for a card, tile, or respective content.

The host server may store electronic documents, pages, or digital content in a local database, memory, or cache. However, the host server may also store and/or access electronic documents, pages, or digital content in a remote database, memory, or cache (for example, in a cloud environment). By way of a non-limiting example, electronic documents, pages, or digital content stored in the local database, memory, or cache may be user-generated content, content space data, content tree data, content metadata and other digital content associated with the various backend applications described herein. The user-generated content may be stored as page objects, document objects, or other data elements.

As noted above, FIG. 1 depicts a system identified as the collaboration system 100. The collaboration system 100 includes a host server infrastructure 102 that can include one or more computing devices or servers configured to allocate resources (including processing resources, memory resources, networking resources and/or other resources) to one or more virtual machines or microservices to perform or coordinate tasks or operations associated with the collaboration system 100.

Specifically, in many embodiments the host server infrastructure 102 can be configured to instantiate a backend application instance configured to communicably couple and/or provide API access in respect of one or more frontend application instances instantiated by one or more client devices. As noted above, a frontend application instance may be a web browser application, and the backend application instance may be a server providing responses to requests initiating from the browser application of HTTP or other similar protocols. This is merely one example; many architectures are possible.

The backend application instance can be configured to communicably couple to multiple client devices, such as requests from a client device 104 associated with a first user authenticated to the collaboration system 100 and requests from a client device 106 associated with a second user not authenticated to the collaboration system 100.

The client device 104 can include a processor 104a, a memory 104b, and a display 104c. The processor 104a and the memory 104b can cooperate to instantiate a client application that renders a graphical user interface over the display 104c. The client application can be configured to solicit information from and provide information to a user of the client device 104.

The frontend application of the client device 104 is configured to communicably couple to a backend application instance instantiated by the host server infrastructure 102. In particular, the client application (also referred to as a "frontend application") can be configured to submit one or more requests to the backend application, including requests for content, as described above.

Specifically, the frontend application can be configured to initiate a request over HTTP to a gateway service 108 of the host server infrastructure 102. The gateway service 108 can be instantiated over dedicated hardware of the host server infrastructure 102 or may be instantiated over shared resources of the host server infrastructure 102, such as with the resource allocations 108a. The resource allocations 108a can include processing resources and memory resources that can cooperate to instantiate an instance of gateway/control software. Many configurations are possible.

Independent of hardware or software configuration, a request from the client device 104 is received at the gateway service 108. The gateway service 108 can first determine whether the request from the client device 104 contains a valid user token associated with an authenticated user of the collaboration system 100.

In particular, before the gateway service 108 accesses a platform backend 110 to retrieve content, the gateway service 108 can be configured to access a permission enforcement platform 112 to determine whether the request received from the client device 104 is permitted.

The platform backend 100 and/or the permission enforcement platform 112 can be instantiated over dedicated hardware of the host server infrastructure 102 or may be instantiated over shared resources of the host server infrastructure 102, such as with the resource allocations 110a, 112a, respectively. The resource allocations 110a, 112a can include processing resources and memory resources that can cooperate to instantiate an instance of gateway/control software.

In particular, a user of the client device 104 may provide credentials via the graphical user interface of the frontend application, rendered over the display 104c. The credentials (and/or an encrypted or salted version thereof) can be passed by the gateway service 108 to the permission enforcement platform 112 to determine whether digital content stored by the platform backend 110 (e.g., in a content database 114) should be returned to the client device 104.

As noted above, prior to determining any intersection of any authorization-denied classification sets, in response to determining that the credentials provided by a user via a frontend application instance do appear in a permissions database 116, the permission enforcement platform 112 can generate a token and provide that token as a user token to the gateway service 108, which in turn may provide/forward the token back to the client device 104, thereby activating a user session at the client device 104. Thereafter, the client device 104 can provide an address, identifier, key, or any other data unique to the desired secure content along with a previously received user token.

As noted with respect to other embodiments described herein, the permission enforcement platform 112 can be configured to extract a user token from each request received (from each client device) and query a directory service 116 to retrieve and/or generate one or more authorization-denied classifications associated with the extracted user token. For example, the permission enforcement platform 112 can be configured to determine what types of content, what object classes, and/or what data sources are permitted to be accessed by the user, role, or other attribute associated with the user token.

Once the permission enforcement platform 112 determines a set of authorization-denied classifications associated with the user token, the permission enforcement platform 112 and/or the gateway service 108 can determine a classification set associated with the requested content. In some cases, previously calculated classifications of the requested content can be stored in a gateway cache 118 or may be stored in the content database 114 as metadata of the content item. In other cases, one or more classifications of the particular requested content can be calculated on demand as requested by the permission enforcement platform 112 and/or the gateway service 108.

In response to receiving a request for content that includes session token unique to a particular already-authenticated user. Herein such a session token can be referred to as a user token (i.e., a request for content from an active session), the gateway service 108 can query the permission enforcement platform 112 to determine validity of the user token and, upon determination by the permission enforcement platform 112 that the token is valid, the gateway service 108 can cause the permission enforcement platform 112 to generate/retrieve a merged set of authorization-denied classifications associated with that user token.

The authorization-denied classifications can be a merged set (e.g., a join) of multiple sets of each associated with a respective one permissions schema. For example, an organization may define an organization-wide permissions schema, a platform-wide schema, in addition to feature-specific schemas. For example, in some cases, the platform backend 110 may be a documentation platform configured to organize pages of content in different workspaces and/or other groups. In these examples, an organization can define space-specific permissions schemas, page-specific permissions schemas, or page subpart-specific permissions schemas. Each individual permissions schema may define one or more rules in respect of which users, roles, teams, (or attributes thereof) are not permitted to access content defined under a particular schema's level.

As noted above and with respect to other embodiments described herein, the permission enforcement platform 112 can be configured to retrieve sets of authorization-denied classifications from each schema in an organization, whether hierarchically organized or otherwise, to generate/calculate/retrieve a single merged set of authorization-denied classifications associated with one particular user having one or more particular user roles. More generally, the permission enforcement platform 112 is configured to associate a user token (including all properties of that user token, such as session age, user role, username, user team, user group, and so on) with a set of classifications of data, or data objects, or attributes thereof, that the user token is not permitted to access.

As a result of the set join operations described herein, it may be appreciated that the permission enforcement platform 112 is configured to automatically resolve conflicts in different schemas by preferring more restrictive permissions over less restrictive permissions. For example, an organization-wide schema may define that users associated with a role of "contractor" are not permitted to access content with a privacy classification of "confidential." A platform-wide schema may define that any user is permitted to access "confidential" content. In this example, a first set of authorization-denied classifications can be generated by the permission enforcement platform 112 in view of the organization-wide schema and a second set of authorization-denied classifications can be generated by the permission enforcement platform 112 in view of the platform-wide schema. When these sets are merged, the resulting set will include the authorization-denied classification of the organization-wide schema, thereby preventing any user token associated with the user role of "contractor" from accessing "confidential" content, regardless of the storage location of that confidential content.

It may be appreciated that the permissions enforcement techniques and methods and systems described herein can be scaled efficiently. In particular, it may be appreciated that significant computational effort is saved by calculating negative permissions in lieu of affirmative access permissions. For example, an individual content item can be associated with dozens of classifications, and an individual user may be associated with dozens of permission-authorized classifications.

A calculation order to determine that all data classifications match with at least one permission of the user may exhibit at least O(n × m) time complexity. By contrast, the examples described herein may exhibit at best O(1) time complexity and at worst O(n) time complexity, where n is the largest set between (1) the merged set of user-specific authorization-denied classifications and (2) the set of classifications associated with a particular requested content item. There is a significant time and computational advantage of architecting a system as described herein based on a join of a first set of token-specific authorization-denied classifications and a second set including classifications of a particular content item.

These foregoing embodiments depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, it may be appreciated that classifications as described herein can be arbitrarily defined or may be defined by a metadata field describing a particular content item or a particular content item location. For example, in a documentation system, a particular content item may have classifications including but not limited to privacy class (e.g., protected status, personally identifying information, and so on); word count; media type; page location; embed location; embed time; embed source; page; space; software platform; collaboration system (e.g., software bundle); geographic location; time of day; and so on. It may be appreciated that any number of classifications can be used as described herein. Some classifications may be time or geography based, some classifications may be static and set by an administrator of a system. In some cases, classifications of data or content can be based on a pair of properties between the content itself and a requesting user. For example, certain content may be accessible only to users whose location is within a particular radius of a content storage location (e.g., this example requires knowledge of both a user location and a content storage location).

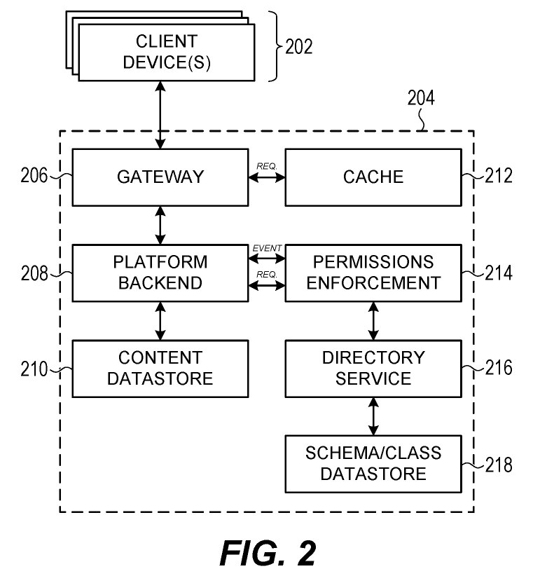

FIG. 2 depicts a simplified system diagram of a collaboration system as described herein. As with other embodiments described herein, the collaboration system 200 can be configured to service requests for content associated with and/or stored by a software platform.

In the illustrated embodiment, the collaboration system 200 is configured to receive requests from one or more devices, identified as the client devices 202.

The collaboration system 200 also includes a set of software instances, operably intercoupled. In particular, the collaboration system 200 includes the backend application instances 204, which in turn can include a gateway instance 206, a platform backend 208, a content datastore 210, a permissions cache 212, a permissions enforcement controller 214, and an authorization-denied categorization and/or content categorization cache 216. The platform backend 208 may also be referred to herein as a platform instance or backend instance. Each software instance can be instantiated by the operation of respective processing and memory resources, which may be hardware resources or may be virtualized resources provided by one or more physical hardware resources. It may be appreciated that many configurations are possible.

As with other embodiments described herein, a request from a client device of the client devices 202 can be received by the gateway instance 206 which can determine whether the request includes a user token and a reference to some content-identifying data, such as an address to particular content (e.g., a page) or an identifier uniquely associated to particular content. As noted above, the user token can define or identify an active session at a frontend application instance instantiated at a client device of the client devices 202. In many embodiments, the user token was generated and disseminated in response to a presentation of valid user credentials via a user interface rendered in a frontend application instance of a client device as described herein.

The content-identifying data included with a request from a client device can take any suitable form or format. In some embodiments, the gateway instance 206 is configured to detect a single content-identifying data format, whereas in others, the gateway instance 206 is configured to detect multiple content-identifying data formats.

Upon recognizing presence of a content-identifying data and a user token, the gateway instance 206 can check the permissions cache 212 to determine whether a permissions decision has been made in respect of the content-identifying data and the user token. In many circumstances, the content-identifying data may not be present in the permissions cache 212 and thus the permissions cache 212 may return a null result or other return signal to the gateway instance 206 indicating a cache miss.

If permissions are not cached by the permissions cache 212, the gateway 206 can communicate with the platform backend 208 to determine whether the detected content-identifying data is actually associated with valid stored data. If the platform backend 208 determines that the content-identifying data is invalid, the platform backend 208 can return a signal to the gateway instance 206 to cause the gateway instance 206 to deny access or to return a 404 or similar server error.

Alternatively, if the platform backend 208 determines that the content-identifying data is associated with valid content, a permissions validation operation can be performed in respect of the user token and the valid stored content. As noted above, such an operation can include accessing a directory service 216 to determine whether the presented user token is valid. The directory service 216 can be additionally configured to cooperate with the permissions enforcement controller 214 and a schema and/or classification datastore 218 to determine a set of schemas associated with that user token. The schemas may be organized in a hierarchy, or may be independent of one another. An example schema may be an organization-wide schema, a platform-specific schema, a page-specific schema and so on.

The permissions enforcement controller 214 can be configured to query the classification datastore 218 to retrieve one or more schemas that associate authorization-denied classifications with particular users, particular user classes, and/or particular user roles within an organization. For each retrieved schema, the permissions enforcement controller 214 can generate a set of authorization-denied classifications in respect of the user token. In another phrasing, each schema can be filtered based on the user token and/or one or more properties of the user token or associated with the user token.

Thereafter, the permissions enforcement controller 214 can be configured to merge each of the generated sets of authorization-denied classifications into a single merged set of authorization-denied classifications. The permissions enforcement controller 214 can be likewise configured to determine one or more classifications descriptive of the requested content. Once each of these sets are generated, the permissions enforcement controller 214 can be configured to intersect the sets to determine whether the resulting intersection is a null set or a non-null set.

In response to determining that the intersection is a null set, the permissions enforcement controller 214 can determine that the user token is authorized to access the content. In this case, the permissions enforcement controller 214 can instruct the platform backend 208 to forward the requested content from the content datastore 210 to the initiating client device.

Alternatively, in response to determining that the intersection is not a null set, the permissions enforcement controller 214 may determine that the requested content is not authorized to be accessed in the active session associated with the user token. In this example, the permissions enforcement controller 214 can instruct the platform backend 208 or the gateway 206 to respond to the original request with a server error or an authorization denied error (e.g., a 403 error).

These foregoing embodiments depicted in FIG. 2 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, it may be appreciated that the architecture and method described herein is particularly suited for servicing and/or completing multiple permissions validation decisions in rapid succession. As a result, an organization can granularize permissions control to any suitable level without sacrificing system performance.

For example, a collaboration system may include or support a multi-platform search functionality. More generally, a "universal search" feature may be accessible from a frontend of one or more software platforms that is configured to return results from multiple software platforms, integrated into a single list of results. In some configurations artificial intelligence or business rules engines can be leveraged to order results in a user-specific way; two different users that conduct semantically identical searches may be presented different search results and/or different search result ordering based on user content interaction history, user preferences, and the like.

In these examples, a system as described herein can serve to efficiently determine permissions in respect of every possible search result of the request; it may be appreciated that conventionally-architected systems with conventional content-based permissions validation may be required to generate and submit network requests in respect of each possible search result, consuming significant network resources, processing resources, and memory resources. In addition, users experience significant wait times as permissions validation operations proceed.

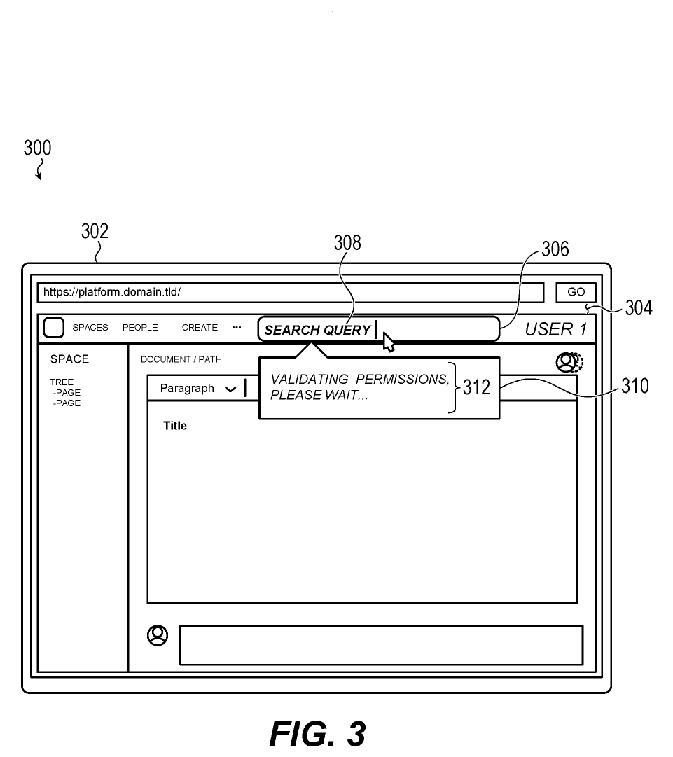

For example, FIG. 3 depicts a client device 300 that includes a display 302. The display 302 can be leveraged by a frontend application instance to render a graphical user interface 304 that includes a universal search input field 306. A user of the client device 300 can provide as input a search query 308 to the universal search input field 306, which in turn may automatically (or in response to an input from the user, such as pressing "return" or similar) generate a search request to a backend application instance that can execute the query and perform permission validation against each potential result. In some cases, an overlay 310 can be rendered in the graphical user interface 304 to provide a message 312 to user of the client device 300 that permissions validations are ongoing. Specifically, each result or possible result may necessitate one or more network calls to and from a permissions management system, one or more queries of a permissions database, directory, or registry, and the like. Such delayed search results may be frustrating to a user of the client device 300.

By contrast, a system as described herein can be configured to determine a merged set of authorization-denied classifications in respect of a user once, thereafter holding in a memory a data structure including each of the classifications for which the particular user is not authorized to access. In these constructions, a result list can be enumerated and/or filtered based on properties thereof; no separate calls to permissions databases or permissions management systems are required. As a result of this architecture, permissions-filtered search results can be displayed for a user in a significantly more efficient and rapid manner.

Furthermore, as noted above, a system as described herein – in which permissions validation operations can execute significantly more efficiently – enable administrators of collaboration platforms to more granularly control permissions. More specifically, administrators can control permissions to any suitable level of granularity without affecting performance of permission validation. For example, in some embodiments, an administrator may desire to restrict internal access to multimedia content, regardless of where stored, during certain hours of the day so as to save bandwidth. In other cases, it may be advantageous to have a global permissions kill-switch to reliably disable all access to particular features or functionality during a security incident. Many constructions and configurations are possible.

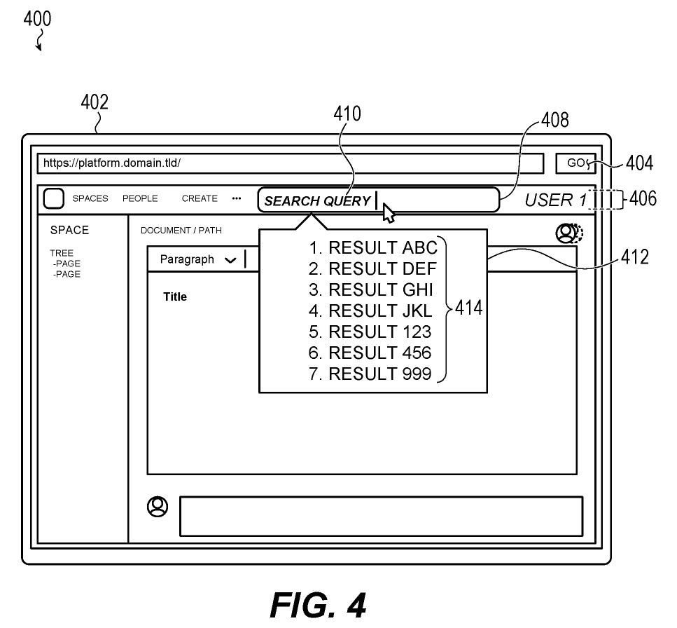

Similarly FIG. 4 depicts a client device 400 that includes a display 402. The display 402 can be leveraged by a frontend application instance to render a graphical user interface 404 in respect of an active session 406. The graphical user interface 404 includes a universal search input field 408. A user of the client device 400 can provide as input a search query 410 to the universal search input field 408, which in turn may automatically (or in response to an input) generate a search request, including a session token identifying the active session 406 (and by extension the user) to a backend application instance that can execute the query and generate (or retrieve from a cache) merged authorization-denied classifications based on the session token. The merged authorization-denied classifications can be generated in respect of a single schema or ruleset, or multiple schemas. In some cases, the authorization-denied classifications can be dynamically calculated whereas in other cases the authorization-denied classifications can be retrieved from a cache. In some cases, the cache can be updated on a schedule or in response to an event indicating a change to one or more schemas; many constructions are possible.

In many embodiments, the authorization-denied classifications generated/retrieved can be used as an exclusion filter when performing the query, enabling results to be returned to the user upon query execution completion. In this manner, a query result panel 412 is able to display query results 414 that respect system permissions across multiple platforms (more specifically, in some cases, query results 414 can include data from two or more platforms, rendered in the same list).

These foregoing embodiments depicted in FIG. 1 - 2 and 4 and the various alternatives thereof and variations thereto are presented, generally, for purposes of explanation, and to facilitate an understanding of various configurations and constructions of a permissions enforcement system and technique, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

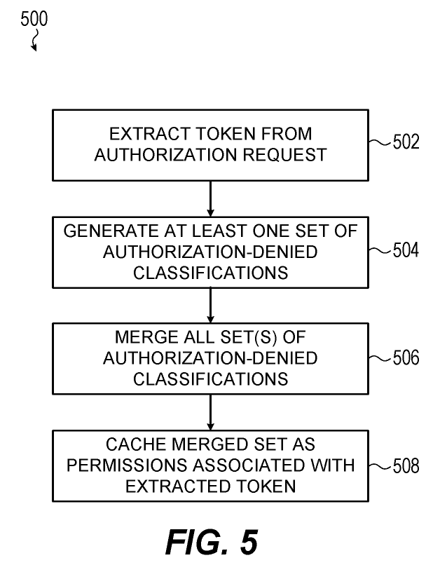

For example, FIG. 5 depicts a flowchart depicting operations of a method of operating a permissions enforcement system as described herein. The method 500 includes operation 502 at which a permissions enforcement system as described herein receives, from an active session of a frontend application instance associated with a software platform of a collaboration system, a request for content.

The request for content (which may be referred to as an authorization request) can include a user token or a session token, which may be extracted at operation 502. Thereafter at operation 504, at least one set of authorization-denied classifications can be generated such as described herein.

Thereafter at operation 506, each determined/obtained set can be merged together to create a single data structure representing all properties, data objects, data sources, metadata fields, categories, tags, or other attributes or combinations thereof that should be inaccessible to a particular user or role associated with the user token or the session token. Finally, at operation 506, the merged set can be cached and associated with the extracted session token or user token.

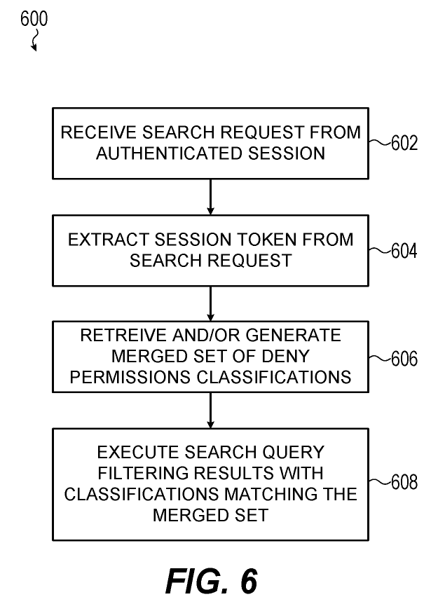

FIG. 6 depicts a flowchart depicting operations of another method of operating a permissions enforcement system as described herein. The method 600 includes operation 602 at which a search request is received from an active, authenticated session, executing on a client device.

Next at operation 604, a session token or user token can be extracted from the search request and, similar to the method described in respect of FIG. 5, at operation 606, one or more authorization-denied classifications can be retrieved from a cache and/or calculated or recalculated (e.g., regenerated) dynamically.

Thereafter, at operation 608, the merged set of authorization-denied classifications can be used as an exclusion filter to filter results of the query. As a result of this architecture, individual permissions checks are not required to be performed against any search result individually. Instead, results can be returned to the active session as soon as such results are returned from a search service.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments described herein are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed only for legitimate, agreed-upon, and reasonable uses.

What is claimed is:

1. A permission enforcement platform for a collaboration system, the collaboration system comprising at least a first software platform and a second software platform, the permission enforcement platform comprising:
a host server comprising a processor and a memory storing executable instructions that when accessed by the processor cause instantiation of an authorization classification handler configured to:
receive a request from a requesting platform, the requesting platform being one of the first software platform or the second software platform;
extract a user token from the request;
generate a first set of authorization-denied classifications based on the user token, each corresponding to a respective one object attribute or a respective one data source of the collaboration system that the user token is not authorized to access;
retrieve a second set of authorization-denied classifications, each corresponding to a respective one object attribute that the user token is not permitted to access within at least one of the first software platform or the second software platform;
merge the first set with the second set into a merged set of authorization-denied classifications; and
provide the merged set of authorization-denied classifications as output to a search platform to configure the search platform to, in response to a query including the user token, exclude any result having at least one object attribute or data source associated with at least one authorization-denied classification of the merged set.

2. The permission enforcement platform of claim 1, wherein:
the request is received in response to the requesting platform receiving a content search request from an active session of a frontend application instance of the requesting platform;
the active session is associated with an authenticated user of the requesting platform; and
the authenticated user is associated with the user token.

3. The permission enforcement platform of claim 2, wherein the authorization classification handler is configured to:
generate a third set of authorization-denied classifications based on the user token, each corresponding to a respective one object attribute or a respective one data source of the first software platform that the authenticated user is not authorized to access; and
merge the first set, the second set, and the third set of authorization-denied classifications into the merged set of authorization-denied classifications.

4. The permission enforcement platform of claim 3, wherein generating the first set of authorization-denied classifications based on the user token comprises constructing and executing a query of an authorization classification datastore configured to store permissions associated with users and roles of the first software platform and the second software platform.

5. The permission enforcement platform of claim 4, wherein the authorization classification handler is configured to:
generate a fourth set of authorization-denied classifications based on the user token, each corresponding to a respective one object attribute or a respective one data source of the second software platform that the authenticated user is not authorized to access; and
merge the first set, the second set, the third set, and the fourth set of authorization-denied classifications into the merged set of authorization-denied classifications.

6. The permission enforcement platform of claim 5, comprising caching the merged set.

7. The permission enforcement platform of claim 1, wherein the authorization classification handler is configured to update the merged set in response to a change in the user token.

8. The permission enforcement platform of claim 1, wherein the authorization classification handler is configured to update the merged set in response to a change in any of the first set or the second set of authorization-denied classifications.

9. The permission enforcement platform of claim 1, wherein the authorization classification handler is configured to redetermine the merged set on a schedule.

10. The permission enforcement platform of claim 1, wherein the authorization classification handler is configured to cache the merged set in a cache.

11. The permission enforcement platform of claim 10, wherein the request is a first request; and
in response to receiving a second request, the authorization classification handler is configured to retrieve the merged set from the cache.

12. A permission enforcement platform for a collaboration system, the permission enforcement platform comprising:
a host server comprising a processor and a memory storing executable instructions that when accessed by the processor cause instantiation of an authorization classification handler configured to:
receive, from a requesting platform, a request comprising a user token issued to a user of the requesting platform having a role within the requesting platform;
generate a first set of authorization-denied classifications based on the request, each corresponding to a respective one object attribute of the requesting platform that the user is not authorized to access;
generate a second set of authorization-denied classifications based on the request, each corresponding to a second respective one object attribute of the requesting platform that the role is not authorized to access;
retrieve a third set of authorization-denied classifications, each corresponding to a third respective one object attribute that no role is authorized to access;
merge the first set, the second set, and the third set into a merged set of authorization-denied classifications; and
provide the merged set of authorization-denied classifications as output to the requesting platform to configure the requesting platform to, in response to a query including the user token, exclude all results having an object attribute associated with at least one authorization-denied classification of the merged set.

13. The permission enforcement platform of claim 12, wherein the authorization classification handler is configured to update the merged set in response to expiration of an active session associated with the user token.

14. The permission enforcement platform of claim 12, wherein the authorization classification handler is configured to update the merged set in response to a change in any of the first set of authorization-denied classifications, the second set of authorization-denied classifications, or the third set of authorization-denied classifications.

15. The permission enforcement platform of claim 12, wherein the authorization classification handler is configured to cache the merged set in a cache.

16. The permission enforcement platform of claim 15, wherein the request is a first request; and
in response to receiving a second authorization request, the classification handler is configured to retrieve the merged set from the cache.

17. A method of searching a collaboration system, the method comprising:
receiving a query request comprising:
a search string provided as input by a user at a graphical user interface of a frontend application instance associated with the collaboration system; and
a user token associated with an active session of the frontend application instance;
providing the user token as input to a permission enforcement platform of the collaboration system;
receiving as output of the permission enforcement platform a list of authorization-denied classifications each associated with a different respective one object attribute;
providing the search string and the list as input to a search service to cause the search service to exclude any result matching an object attribute associated with the list;
receiving a first response from the search service; and
providing a second response to the frontend application instance to cause the graphical user interface to display at least one result of the first response.

18. The method of claim 17, wherein at least one object attribute of the list comprises a document object attribute.

19. The method of claim 17, wherein at least one object attribute of the list comprises an object type.

20. The method of claim 17, wherein at least one object attribute of the list comprises an indication whether an object is cross-linked between platforms of the collaboration system.
